(19) United States
(12) Patent Application Publication
(10) Pub. No.: US 2007/0029495 A1
(43) Pub. Date: Feb. 8, 2007

(54) Alignment method and apparatus for pixilated detector

(76) Inventors: Micheal J. Petrillo, Pleasanton, CA (US); Sorin V. Cora, Anaheim, CA (US); Hamid Naima, Pleasanton, CA (US); Sanyi Tseng, San Jose, CA (US); John F. Vessel, Kirtland, OH (US)

Correspondence Address: PHILIPS INTELLECTUAL PROPERTY & STANDARDS, 595 MINER ROAD, CLEVELAND, OH, 44143, US

(21) Appl. No.: 10/571,748

(22) PCT Filed: Sep. 1, 2004
(86) PCT No.: PCT/IB04/51655

§ 371 Date: Mar. 14, 2006

Related U.S. Application Data
(60) Provisional application No. 60/505,538, filed on Sep. 24, 2003.

(51) Int. Cl. G01T 1/24

(52) U.S. Cl. 250/370.14

(57) ABSTRACT

A detector (20) for a nuclear imaging system (10) includes a plurality of sockets (44) which each support an array of individual detector elements (48). Each socket (44) includes a plurality of electrical connectors (54) and socket alignment structures (72). The sockets (44), carrying the detector elements (48), are installed onto a circuit board (40). The circuit board (40) includes a plurality of electrical conductive openings (52) which electrically connect with the electrical connectors (54) and alignment structures (74) which mate with the socket alignment structures (72) to align the sockets (44) and the individual detector elements (48) to the circuit board (40). A collimator (24) is mounted and aligned to a frame (60). The frame (60) and the circuit board (40) each include aligning structures to align the collimator (24) to the circuit board (40) and the individual detector elements (48).

### DESCRIPTION

The present invention relates to the diagnostic imaging systems and methods. It finds particular application in conjunction with the nuclear imaging systems using solid state detectors (SSD) and will be described with particular reference thereto. It will be appreciated that the invention is also applicable to the other imaging systems using pixilated imaging devices, and the like.

Diagnostic nuclear imaging is used to study a radionuclide distribution in a subject. Typically, one or more radiopharmaceutical or radioisotopes are injected into a subject. The radiopharmaceutical is commonly injected into the subject's bloodstream for imaging the circulatory system or for imaging specific organs, which absorb the injected radiopharmaceutical. A radiation detector is placed adjacent to the surface of the subject to monitor and record emitted radiation. Often, the detector is rotated or indexed around the subject to monitor the emitted radiation from a plurality of directions. These projection data sets are reconstructed into a three-dimensional image representative of the radiopharmaceutical distribution within the subject.

Commonly, each detector head includes an array of photomultiplier tubes (PMTs) facing a single large scintillation crystal. Each radiation event generates a corresponding flash of light that is seen by the closest photomultiplier tubes. Each photomultiplier tube that sees an event puts out a corresponding analog pulse. The analog pulses from the individual PMT's are digitized and combined to generate x and y spatial coordinates of the location of scintillation event on the crystal face.

In recent years, however, a use of solid state detectors in nuclear cameras has proved to be beneficial. Solid state detectors include a large array of individual detectors each of which utilizes the photoelectric effect to detect radiation. More specifically, the received radiation photons liberate electrons from their orbits around atoms of the target material. The electrons are detected as an electrical signal.

Typically, solid state detector designs incorporate detector modules which each include a smaller array of individual detector elements, e.g. 256. The individual detector elements are few millimeters square. The detector modules, e.g. 50-60 in number, are installed in array on the motherboard, which is typically 20-40 centimeters on each side to define the active surface of the detector. In these designs, the module has contact pins, with which each module plugs into the motherboard. The electrical contact pins are thin and fabricated of electrically conductive metal. The pins tend to flex and bend slightly during insertion into mating holes in the motherboard permitting each module to skew slightly. Misalignments among the modules produce inaccuracies in the individual detector element grid that cause corresponding inaccuracies in the resultant image. The installation of the modules into a whole array with high tolerances to form a precisely rectangular grid of individual detector elements is difficult.

Nuclear cameras, particularly SPECT cameras, have a collimator that restricts the directions from which radiation can approach and strike the detector. The collimators have a grid of thin walls which overlie gaps or interfaces between individual detector elements. Although the collimator grids can be manufactured with high tolerances, skewed or shifted detector modules cause misalignment between the collimator and the detector elements. Even small misalignments place the collimator walls over larger portions of the active faces of some detector elements than others. Variations in the degree, to which detector element active faces are shadowed by the collimator grid, alters the effective size of some detector elements relative to others changing the relative amount of radiation received and degrading the resultant image.

There is a need for an alignment technique that would reduce the costs and complexity of alignment. The present invention provides a new imaging apparatus and method which overcomes the above-referenced problems and others.

In accordance with one aspect of the present invention, a detector for a nuclear imaging system is disclosed. The detector comprises a plurality of sockets which each support an array of individual detector elements. Each socket includes a plurality of electrical connectors and a socket alignment structure. The sockets are received on a circuit board that includes a plurality of electrical connection means which electrically connect with the electrical connectors, and a circuit board alignment structure which mates with the socket alignment structure to align the sockets and the individual detector elements to the circuit board. A means is used for mounting a collimator to the circuit board in alignment with the circuit board.

In accordance with another aspect of the present invention, a method of assembling a detector for a nuclear imaging system is disclosed. A plurality of sockets, which each include an array of individual detector elements, a plurality of electrical connectors, and socket alignment structures, is inserted into a circuit board which includes a plurality of electrical connections which electrically connect with the electrical connectors as the sockets are inserted, and circuit board alignment structures, which mate with the socket alignment structures as the socket is mounted to align the arrays of detector elements with the circuit board and each other. A collimator mounting means is mounted and aligned to the circuit board such that the collimator mounting means is aligned with the arrays of detector elements.

One advantage of the present invention resides in improving performance of detector by precisely aligning individual receptive elements to the openings in collimator.

Another advantage of the present invention resides in using separate non conducting alignment structures thus reducing cost and complexity of alignment.

Still further advantages and benefits of the present invention will become apparent to those of ordinary skill in the art upon reading and understanding the following detailed description of the preferred embodiments.

The invention may take form in various components and arrangements of components, and in various steps and arrangements of steps. The drawings are only for purposes of illustrating the preferred embodiments and are not to be construed as limiting the invention.

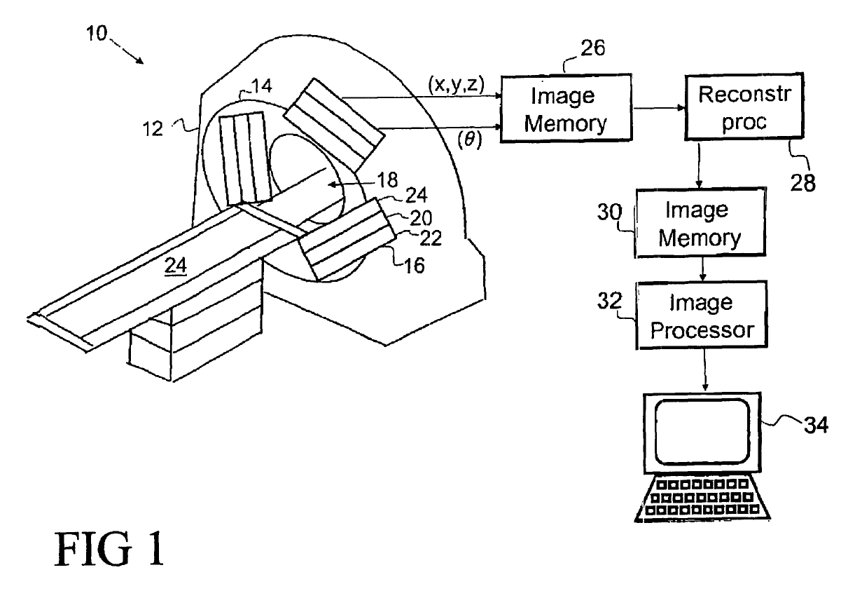

FIG. 1 is a diagrammatic illustration of nuclear imaging system in accordance with the present invention;

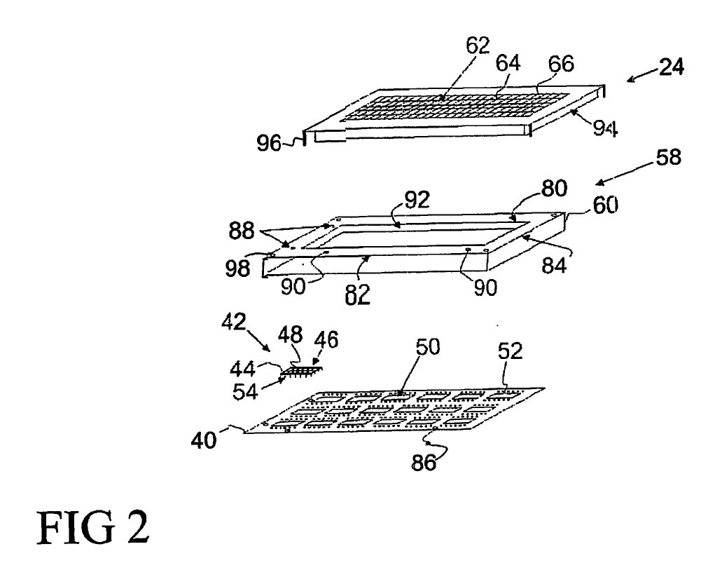

FIG. 2 is a diagrammatic illustration of a detector;

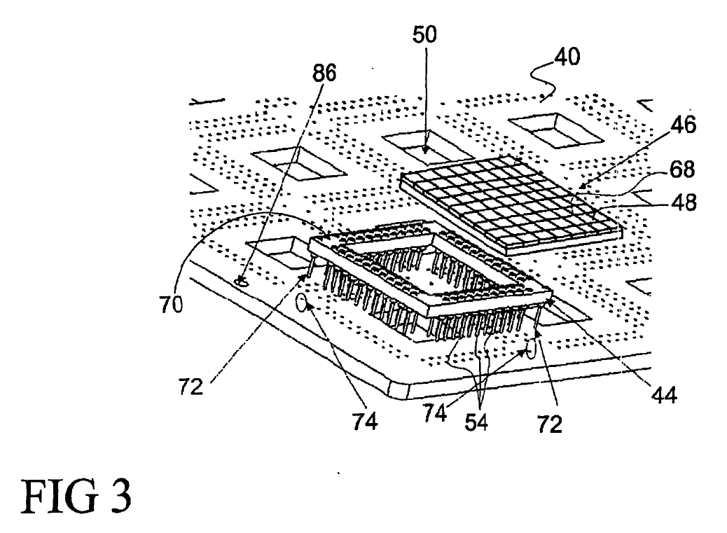

FIG. 3 is a diagrammatic illustration of a portion of a substrate; and

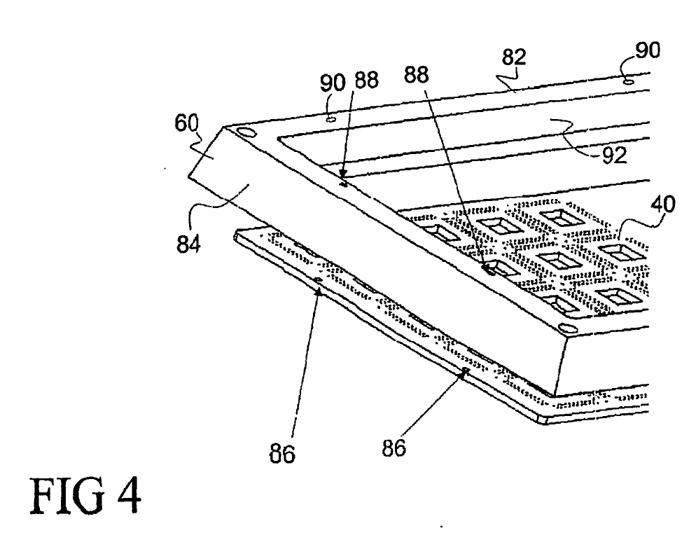

FIG. 4 is a diagrammatic illustration of a portion of a substrate and a frame.

With reference to FIG. 1, a nuclear imaging device 10 typically includes a stationary gantry 12 that supports a rotating gantry 14. One or more detector heads 16 are carried by the rotating gantry 14 to detect radiation events emanating from a region of interest or examination region 18. Each detector head includes a two-dimensional array of detector elements or detector 20. The detector arrays are preferably solid-state detectors, which convert gamma radiation directly into electrical charge. Each head 16 includes circuitry 22 for converting each radiation response into a digital signal indicative of its location (x, y) on the detector face and its energy (z). A collimator 24 controls the direction and angular spread, from which each detector element of the array 20 can receive radiation.

Typically, an object to be imaged is injected with one or more radiopharmaceutical or radioisotopes and placed in the examination region 18 supported by a couch 26. The presence of the radiopharmaceuticals within the object produces emission radiation from the object. Radiation is detected by the detector heads 16 which are, preferably, angularly indexed or rotated around the examination region 18 to collect the emission data from a plurality of directions. The projection emission data (x, y, z) and an angular position (θ) of each detector head 16 around the examination region 18 are stored in a data storage 28. A reconstruction processor 30 processes the event and detector orientation data from the data storage 28 into a volumetric image representation. The image representation is then stored at a volume image memory 32 for manipulation by a video processor 34 and display on an image display 36 such as a video monitor, printer, or the like.

With reference to FIG. 2, the detector 20 includes a substrate or a circuit board 40, on which detector modules 42 are mounted in a close packed tile arrangement. Each detector module 42 includes a socket 44 and a crystal array 46. Each crystal array 46 is preferably divided into 256 individual detector elements or pixels 48. The substrate 40 includes rectangular openings 50. A plurality of holes or pin sockets 52 is disposed about the openings 50 to electrically connect with the detector modules 42. More specifically, each module's socket 44 employs electrical connectors or pins 54 disposed about its perimeter. The electrical connector pins 54 are inserted into the plurality of mating pin sockets 52 to establish the electrical connections with the crystal 48 and the associated electrical components disposed on the substrate 40 or in the detector head 16.

With continuing reference to FIG. 2, the detector 20 further includes a frame 60 that is mounted to the substrate 40 to support the collimator 24. The collimator 24 includes a lead grid 62 that is made from pieces that mate together to make a square matrix of apertures 64, which spans the entire array of detector modules. As explained in greater detail below, the frame 60 positions the collimator 24 such that vanes 66 that define each square collimator aperture 64 are aligned with the gaps or interfaces 68 between individual detector elements 48 on the circuit board 40.

With reference to FIG. 3, each socket 44 includes contact portion 70 at which the crystal array 46 is electrically connected to the electrical contact pins 54. Each socket further includes two or more alignment pins 72, positioned diagonally from each other. Corresponding mating alignment openings or holes 74 are provided on the substrate 40. The alignment pins 72 are preferably made of high strength steel, but other rigid, hard to deform materials are also contemplated. The placement and cross section of the alignment pins 72 and the alignment openings 74 are manufactured with high precision. The interaction of the alignment pins 72 and holes 74, as the sockets 44 are inserted into the circuit board 40, precisely aligns the detector modules 42 and the individual detector elements 48. Of course, the alignment mechanism might be reversed, with the pins provided on the substrate and mating openings on the socket.

With reference again to FIG. 2 and further reference to FIG. 4, the frame 60 has a rectangular face 80 having a longer dimension 82 and a shorter dimension 84. Four alignment openings are defined through the frame 60 and match with alignment openings 86 defined in the substrate 40. More specifically, a pair of primary frame alignment openings 88 is defined in the shorter dimension 84, and a pair of secondary frame alignment openings 90 is defined in the longer dimension 82. Typically, only one pair of frame alignment openings is used to mount the frame 60 to the substrate 40, to account for the effect of thermal dilatation. Preferably, the frame alignment openings 88 positioned along the shorter dimension 84 are used to mount the frame 60 to the substrate 40, although both pairs are used in the alignment process. The system is constructed from different materials, each of which expands and contracts at different rates. Having the alignment structures positioned across the shorter dimension 84 reduces the effect of thermal stress. Of course, if the materials used in the system are changed to reduce thermal stress, the secondary frame alignment openings 90 positioned about the longer dimension 82 might be used.

With continuing reference to FIGS. 2, 3 and 4, once the frame 60 is aligned with the circuit board 40, it is also aligned with the detector modules 42 and the individual detector elements 48. To align with the collimator 24, the frame 60 has inside surfaces 92 around its central opening that mate with exterior surfaces 94 of the collimator 24. Alternatively, the collimator 24 can have a flange with alignment and mounting pins 96 that are received in alignment and mounting apertures 98 in the frame. In this manner, the collimator apertures 64 are fixedly aligned with the individual detector elements 48 with a tolerance of +/−10 micron.

The invention has been described with reference to the preferred embodiments. Modifications and alterations may occur to others upon a reading and understanding of the preceding detailed description. It is intended that the invention be constructed as including all such modifications and alterations insofar as they come within the scope of the appended claims or the equivalents thereof.

1. A detector for a nuclear imaging system, the detector comprising:
a plurality of sockets which each support an array of individual detector elements, each socket including:
a plurality of electrical connectors, and
a socket alignment structures;
a circuit board for receiving sockets, which circuit board includes:
a plurality of electrical connection means which electrically connect with the electrical connectors, and
a circuit board alignment structure which mates with the socket alignment structure to align the sockets and the individual detector elements to the circuit boards; and
a means for mounting a collimator to the circuit board in alignment with the circuit board.

2. The detector as set forth in claim 1, wherein the socket alignment structure and the mating circuit board alignment structure includes rigid pins and apertures of like cross-section.

3. The detector as set forth in claim 2, wherein the rigid pins are not used for transmitting electrical signals between the sockets and the circuit board.

4. The detector as set forth in claim 1, wherein the collimator mounting means includes a frame and further including:
an aligning means for aligning the frame and the circuit board

5. The detector as set forth in claim 4, wherein the individual detector elements are separated by interfaces or gaps and wherein the collimator includes mechanical elements which define a plurality of apertures the mechanical elements being aligned with the interfaces or gaps such that the apertures are centered on and aligned with the individual detector elements.

6. The detector as set forth in claim 4, wherein the aligning means includes:
at least two alignment holes defined in the framed, and
at least two matching holes defined in the circuit board.

7. The detector as set forth in claim 5, wherein the frame has a rectangular face including:
a longer dimensions, and
a shorter dimension,
the at least two frame alignment holes being disposed along the shorter dimension to reduce an effect of thermal dilatation.

8. The detector as set forth in claim 1, wherein the socket alignment structures includes rigid pins positioned diagonally from each other.

9. The detector as set forth in claim 8, wherein the connectors are pins of relatively soft metal that tend to deform as the sockets are received on the circuit board.

10. A method of assembling a detector for a nuclear imaging system comprising:
inserting each of a plurality of sockets, which each include an array of individual detector elements, a plurality of electrical connectors, and socket alignment structures into a circuit board which includes a plurality of electrical connections which electrically connect with the electrical connectors as the sockets are inserted, and circuit board alignment structures, which mate with the socket alignment structures as the socket is mounted to align the arrays of detector elements with the circuit board and each other; and
aligning and mounting a collimator mounting means to the circuit board such that the collimator mounting means is aligned with the arrays of detector elements.

11. The method as set forth in claim 10, wherein the collimator mounting means includes a frame which mounts a collimator in fixed alignment thereto, hence to the circuit board and the individual detector arrays.

12. The method as set forth in claim 11, wherein the individual detector elements have interfaces therebetween and the collimator has mechanical elements, which define apertures, the mechanical elements being aligned with the individual detector element array interfaces.

13. A detector for a nuclear imaging system, the detector comprising:
a substrate including a plurality of sets of electrically conductive holes and alignment holes of precise cross section; and
a plurality of detector modules each detector module including a plurality of electrically conductive connection pins which are sufficiently soft to tend to bend and rigid alignment pins of the precise cross section, each set of holes being configured to receive one of the modules.

14. The detector as set forth in claim 13, wherein each detector module includes:
individual detector elements which are electrically connected to the electrically conductive connector pins, the individual detector elements being mounted in a rectangular array separated from each other by a rectangular grid of interfaces.

15. The detector as set forth in claim 13, wherein the substrate defines a plurality of substrate alignment holes and further including:
a frame which defines alignment holes, which align with the substrate alignment holes.

16. The detector as set forth in claim 15, wherein the frame has a rectangular face which includes:
a longer dimensions, and
a shorter dimension; and
the alignment holes including two alignment holes defined in the shorter dimension to reduce an effect of thermal dilatation.

17. The detector as set forth in claim 15, wherein the frame includes a collimator mounting means for mounting the collimator in precise alignment therewith, the collimator including:
radiation blocking element that form a rectangular grid which overlays the interface grids of the individual detector elements which are mounted to the substrate when the collimator is mounted in and aligned with the frame that is aligned with the substrate.

18. A detector for a nuclear imaging system, the detector comprising:
a plurality of detector elements selectively securable to a circuit board, the detector elements being separated by gaps;
a collimator comprising mechanical elements which define a plurality of apertures; and
a collimator alignment mechanism, said collimator alignment mechanism aligning the mechanical elements with the gaps separating the detector elements such that the apertures are aligned with the detector elements.

19. The detector of claim 18 further comprising a detector element alignment mechanism, said detector element alignment mechanism aligning the detector modules on the circuit board.

20. The detector of claim 18 wherein each aperture is aligned with an individual detector element.
